(19) United States
(12) Patent Application Publication
(10) Pub. No.: US 2022/0277406 A1
(43) Pub. Date: Sep. 1, 2022

(54) METHOD OF OPTIMIZING AN INDUSTRIAL PROCESS BASED ON ENVIRONMENTAL FACTORS

(71) Applicant: Covestro LLC, Pittsburgh, PA (US)

(72) Inventors: Devin W. Ulam, Pittsburgh, PA (US); David D. Steppan, Gibsonia, PA (US); Susan B. McVey, Houston, PA (US); Stephen J. Hoskins, McMurray, PA (US); William C. Gower, Beaver, PA (US)

(21) Appl. No.: 17/631,996

(22) PCT Filed: Aug. 4, 2020
(86) PCT No.: PCT/US2020/044825

§ 371 Date: Feb. 1, 2022

Related U.S. Application Data
(60) Provisional application No. 62/882,638, filed on Aug. 5, 2019.

(51) Int. Cl. G06Q 50/04; G06Q 10/06; G05B 19/4155

(52) U.S. Cl. CPC G06Q 50/04; G06Q 10/06316; G05B 19/4155; G05B 2219/31449

(57) ABSTRACT

A computer-implemented method of optimizing an industrial process includes comparing current environmental condition data to historic environment condition data for at least one day preceding a specified day. The method also includes determining a visual state from a plurality of visual states for the at least one day based on the comparison between the current environmental condition data and the historic environment condition data. The method further includes generating a calendar interface comprising a plurality of days preceding the specified day and corresponding to a plurality of visual representations. The method further includes generating a graphical user interface comprising historical data for at least one type of industrial process.

### BACKGROUND

### Field

The present disclosure relates to computer-implemented methods of optimizing an industrial process. In non-limiting embodiments, the method includes generating one or more graphical user interfaces. In non-limiting embodiments, the method includes modifying at least one process parameter of a specified type of industrial process based on at least one environmental parameter.

### Description of Related Art

Industrial processes for the manufacture of products may be sensitive to environmental conditions in ways that alter the material properties of the finished product. Some industrial processes, for example the mixing of raw materials to manufacture foam, may be particularly sensitive to environmental conditions such that careful monitoring and accounting of environmental conditions must be undertaken during manufacturing to ensure the finished product has acceptable physical and chemical properties. Particular environmental conditions that may affect industrial processes may include temperature, pressure, humidity, and grains of moisture. In order to account for changes or abnormalities in such environmental conditions, control parameters of the manufacturing process may be altered.

Existing methods for altering such control parameters generally rely on experience of a process operator to configure the control parameters prior to beginning the manufacturing process and make on-the-fly adjustments to the control parameters during the manufacturing process. Such configuration and adjustment to the control parameters may not be repeatable and may vary from operator to operator and/or production run to production run, sometimes leading to unpredictable and unsatisfactory results.

### SUMMARY

According to a non-limiting embodiment or aspect, provided is a computer-implemented method of optimizing an industrial process based on at least one environmental parameter. The method includes comparing, with at least one processor, current environmental condition data to historic environment condition data for at least one day preceding a specified day. The method also includes determining, with at least one processor, a visual state from a plurality of visual states for the at least one day based on the comparison between the current environmental condition data and the historic environment condition data. The method further includes generating, with at least one processor, a calendar interface including a plurality of days preceding the specified day and corresponding to a plurality of visual representations. At least one visual representation corresponding to the at least one day includes the visual state. The method further includes, in response to receiving a user selection of the at least one day of the plurality of days, generating a graphical user interface including process data for the at least one day, the process data including historical data for at least one type of industrial process.

In some non-limiting embodiments or aspects, the method may further include determining, with at least one processor, the current environmental condition data for the specified day for a region in which the at least one type of industrial process is being performed.

In some non-limiting embodiments or aspects, determining the visual state of the at least one day may include determining a subset of days of the plurality of days based on an availability of data for the at least one specified type of industrial process, and determining a visual state for each day of the subset of days based on the comparison of the current environmental condition data to historic environment condition data for that day. Each visual state of the plurality of visual states is based on a differential between the current environmental condition data and the historic environment condition data.

In some non-limiting embodiments or aspects, the method may further include generating a plurality of visual representations from the plurality of visual states. The plurality of visual states includes a plurality of colors, and each visual representation of the plurality of visual representations represents a different day of the plurality of days.

In some non-limiting embodiments or aspects, the method may further include modifying at least one process parameter for an industrial process based on the process data for the at least one day.

In some non-limiting embodiments or aspects, the method may further include controlling an ingredient addition device based on the at least one process parameter.

In some non-limiting embodiments or aspects, the graphical user interface including process data may include at least one graph showing a plurality of discrete instances of the industrial process according to at least one process parameter. The method may further include receiving a user selection of at least one discrete instance of the industrial process from the at least one graph, and generating a graphical user interface including process parameters for the at least one discrete instance of the industrial process.

According to a non-limiting embodiment or aspect, provided is a computer-implemented method of optimizing an industrial process based on at least one environmental parameter. The method includes receiving, with at least one processor, a specified type of industrial process. The method further includes determining, with at least one processor, a plurality of days preceding a specified day for which process data associated with the specified type of industrial process is stored in a database. The method further includes determining, with at least one processor, historic environment condition data for each day of the plurality of days. The method further includes comparing, with at least one processor, current environmental condition data to the historic environment condition data for each of the plurality of days. The method further includes determining, with at least one processor, a visual state from a plurality of visual states for each day of the plurality of days based on the comparison between the current environmental condition data and the historic environment condition data for each day. The method further includes generating, with at least one processor, a calendar interface including a plurality of visual representations. Each visual representation corresponds to a day of the plurality of days and includes the visual state determined for the corresponding day.

In some non-limiting embodiments or aspects, the method may further include receiving a user selection of at least one visual representation of the plurality of visual representations, and generating a graphical user interface including process data for at least one day corresponding to the at least one visual representation of the user selection. The process data includes historical data for the specified type of industrial process.

In some non-limiting embodiments or aspects, the method may further include determining, with at least one processor, the current environmental condition data for the specified day for a region in which the specified type of industrial process is being performed.

In some non-limiting embodiments or aspects, the plurality of visual states may include a plurality of colors.

In some non-limiting embodiments or aspects, the method may further include modifying at least one process parameter for the specified type of industrial process based on the process data for the at least one day.

In some non-limiting embodiments or aspects, the method may further include controlling an ingredient addition device based on the at least one process parameter.

According to a non-limiting embodiment or aspect, provided is a computer-implemented method of optimizing an industrial process based on at least one environmental parameter. The method includes receiving, with at least one processor, a specified type of industrial process. The method further includes determining, with at least one processor, a plurality of days preceding a specified day for which process data associated with the specified type of industrial process is stored in a database. The method further includes determining, with at least one processor, historic environment condition data for each day of the plurality of days. The method further includes comparing, with at least one processor, current environmental condition data to the historic environment condition data for each of the plurality of days. The method further includes selecting, with at least one processor, at least one day of the plurality of days based on the comparison between the current environmental condition data and the historic environment condition data for each day of the plurality of days. The method further includes retrieving, with at least one processor, process data corresponding to the at least one day from a database. The method further includes configuring process parameters for performing the industrial process based on the process data retrieved from the database.

In some non-limiting embodiments or aspects, the method may further include determining, with at least one processor and during performance of the specified type of industrial process, a change in the current environmental condition data. The method may further include, in response to determining the change, determining, with at least one processor, at least one different day of the plurality of days based on a comparison between the changed current environmental condition data and historic environment condition data for the at least one different day. The method may further include modifying, with at least one processor, at least one of the process parameters for the specified type of industrial process during performance of the specified type of industrial process.

According to a non-limiting embodiment or aspect, provided is a computer program product for optimizing an industrial process based on at least one environmental parameter including at least one non-transitory computer-readable medium including one or more instructions that, when executed by at least one processor, cause the at least one processor to compare current environmental condition data to historic environment condition data for at least one day preceding a specified day. The instructions further cause the at least one processor to determine a visual state from a plurality of visual states for the at least one day based on the comparison between the current environmental condition data and the historic environment condition data. The instructions further cause the at least one processor to generate a calendar interface including a plurality of days preceding the specified day and corresponding to a plurality of visual representations. At least one visual representation corresponding to the at least one day includes the visual state. The instructions further cause the at least one processor to, in response to receiving a user selection of the at least one day of the plurality of days, generate a graphical user interface including process data for the at least one day, the process data including historical data for at least one type of industrial process.

In some non-limiting embodiments or aspects, the one or more instructions may further cause the at least one processor to determine the current environmental condition data for the specified day for a region in which the at least one type of industrial process is being performed.

In some non-limiting embodiments or aspects, the one or more instructions that cause the at least one processor to determine the visual state of the at least one day may cause the at least one processor to determine a subset of days of the plurality of days based on an availability of data for the at least one specified type of industrial process, and determine a visual state for each day of the subset of days based on the comparison of the current environmental condition data to historic environment condition data for that day. Each visual state of the plurality of visual states is based on a differential between the current environmental condition data and the historic environment condition data.

In some non-limiting embodiments or aspects, the one or more instructions may further cause the at least one processor to generate a plurality of visual representations from the plurality of visual states. The plurality of visual states includes a plurality of colors, and each visual representation of the plurality of visual representations represents a different day of the plurality of days.

In some non-limiting embodiments or aspects, the one or more instructions may further cause the at least one processor to modify at least one process parameter for an industrial process based on the process data for the at least one day.

In some non-limiting embodiments or aspects, the one or more instructions may further cause the at least one processor to control an ingredient addition device based on the at least one process parameter.

In some non-limiting embodiments or aspects, the graphical user interface including process data may include at least one graph showing a plurality of discrete instances of the industrial process according to at least one process parameter. The one or more instructions further cause the at least one processor to receive a user selection of at least one discrete instance of the industrial process from the at least one graph, and generate a graphical user interface including process parameters for the at least one discrete instance of the industrial process.

According to a non-limiting embodiment or aspect, provided is a system for optimizing an industrial process based on at least one environmental parameter. The system includes at least one processor programmed and/or configured to compare current environmental condition data to historic environment condition data for at least one day preceding a specified day. The at least one processor is further programmed and/or configured to determine a visual state from a plurality of visual states for the at least one day based on the comparison between the current environmental condition data and the historic environment condition data. The at least one processor is further programmed and/or configured to generate a calendar interface including a plurality of days preceding the specified day and corresponding to a plurality of visual representations. At least one visual representation corresponding to the at least one day includes the visual state. The at least one processor is further programmed and/or configured to, in response to receiving a user selection of the at least one day of the plurality of days, generate a graphical user interface including process data for the at least one day, the process data including historical data for at least one type of industrial process.

In some non-limiting embodiments or aspects, the at least one processor may be further programmed and/or configured to determine the current environmental condition data for the specified day for a region in which the at least one type of industrial process is being performed.

In some non-limiting embodiments or aspects, when determining the visual state of the at least one day, the at least one processor may be programmed and/or configured to determine a subset of days of the plurality of days based on an availability of data for the at least one specified type of industrial process, and determine a visual state for each day of the subset of days based on the comparison of the current environmental condition data to historic environment condition data for that day. Each visual state of the plurality of visual states is based on a differential between the current environmental condition data and the historic environment condition data.

In some non-limiting embodiments or aspects, the at least one processor may be further programmed and/or configured to generate a plurality of visual representations from the plurality of visual states. The plurality of visual states includes a plurality of colors, and each visual representation of the plurality of visual representations represents a different day of the plurality of days.

In some non-limiting embodiments or aspects, the at least one processor may be further programmed and/or configured to modify at least one process parameter for an industrial process based on the process data for the at least one day.

In some non-limiting embodiments or aspects, the at least one processor may be further programmed and/or configured to control an ingredient addition device based on the at least one process parameter.

In some non-limiting embodiments or aspects, the graphical user interface including process data may include at least one graph showing a plurality of discrete instances of the industrial process according to at least one process parameter. The at least one processor may be further programmed and/or configured to receive a user selection of at least one discrete instance of the industrial process from the at least one graph, and generate a graphical user interface including process parameters for the at least one discrete instance of the industrial process.

According to a non-limiting embodiment or aspect, provided is a method of producing a chemical product from a reaction mixture containing at least two ingredients. The method includes: generating, with at least one processor, at least one machine learning model configured to determine predicted reaction mixture data based on at least one input environmental parameter and at least one input product property. The predicted reaction mixture data may include at least one of a composition of a reaction mixture and process conditions for a reaction mixture. The method may further include training, with at least one processor, the at least one machine learning model based on a data set including data for a plurality of production instances of producing the chemical product. The data for each production instance may include reaction mixture composition data, at least one environmental parameter for a production site of the chemical product, and at least one product property of the chemical product. The method may further include determining, with at least one processor, the predicted reaction mixture data based on processing input data including a measured environmental parameter and at least one target product property according to the at least one machine learning model. The method may further include producing the chemical product based on the predicted reaction mixture data. The method may further include obtaining at least one measured product property of the chemical product produced based on the predicted reaction mixture data. The method may further include modifying, with at least one processor, the at least one model based on the at least one measured product property and the predicted reaction mixture data.

In some non-limiting embodiments or aspects, the method may further include, prior to training the at least one machine learning model, removing, with at least one processor, outliers from the data set based on a statistical algorithm.

In some non-limiting embodiments or aspects, the method may further include receiving, via a graphical user interface, at least one of the at least one measured environmental parameter and the at least one target product property.

In some non-limiting embodiments or aspects, the method may further include displaying, on a graphical user interface, the predicted reaction mixture data.

In some non-limiting embodiments or aspects, the at least one target product property includes at least two target product properties.

In some non-limiting embodiments or aspects, the at least one measured environmental parameter includes at least two measured environmental parameters.

In some non-limiting embodiments or aspects, the at least one measured environmental parameter includes at least one of the following: an air pressure, an air temperature, an air relative humidity, or combinations thereof.

In some non-limiting embodiments or aspects, the at least one target product property is at least one of a raw density according to DIN EN ISO 845 and a compression load deflection at 40% compression according to EN ISO 3386.

In some non-limiting embodiments or aspects, the chemical product includes a polyurethane foam, and the reaction mixture includes: a polyisocyanate; a polyisocyanate-reactive compound; a blowing agent; or combinations thereof. In an embodiment, the polyisocyanate-reactive compound includes water.

In some non-limiting embodiments or aspects, determining the predicted reaction mixture data includes modifying a predetermined mixture composition by adjusting at least one of: a molar ratio of isocyanate groups to isocyanate-reactive groups; an amount of blowing agent; an amount of physical blowing agent relative to an amount of chemical blowing agent; or combinations thereof.

In some non-limiting embodiments or aspects, the method may further include, while producing the chemical product based on the predicted reaction mixture, receiving an updated measured environmental parameter from the production site of the chemical product. The method may further include updating, with at least one processor, the predicted reaction mixture data based on the updated measured environmental parameter.

In some non-limiting embodiments or aspects, updating the predicted reaction mixture data based on the updated measured environmental parameter includes adjusting at least one of the composition of the reaction mixture and process conditions for the reaction mixture.

In some non-limiting embodiments or aspects, the method may further include, while producing the chemical product based on the predicted reaction mixture, receiving an updated measured environmental parameter from the production site of the chemical product. The method may further include determining not to adjust the predicted reaction mixture data based on the updated measured environmental parameter.

In some non-limiting embodiments or aspects, the method may further include, determining, with at least one processor, that the updated measured environmental parameter is different than the measured environmental parameter. The method may further include adjusting, with at least one processor, at least one of the composition of the reaction mixture and process conditions for the reaction mixture in response to the determination that the updated measured environmental parameter is different than the measured environmental parameter.

In some non-limiting embodiments or aspects, receiving an updated measured environmental parameter includes receiving at least two updated measured environmental parameters.

Further embodiments or aspects are set forth in the following numbered clauses:

Clause 1. A computer-implemented method of optimizing an industrial process based on at least one environmental parameter, comprising: comparing, with at least one processor, current environmental condition data to historic environment condition data for at least one day preceding a specified day; determining, with at least one processor, a visual state from a plurality of visual states for the at least one day based on the comparison between the current environmental condition data and the historic environment condition data; generating, with at least one processor, a calendar interface comprising a plurality of days preceding the specified day and corresponding to a plurality of visual representations, wherein at least one visual representation corresponding to the at least one day comprises the visual state; and in response to receiving a user selection of the at least one day of the plurality of days, generating a graphical user interface comprising process data for the at least one day, the process data including historical data for at least one type of industrial process.

Clause 2. The computer-implemented method of clause 1, further comprising determining, with at least one processor, the current environmental condition data for the specified day for a region in which the at least one type of industrial process is being performed.

Clause 3. The computer-implemented method of clause 1 or 2, wherein determining the visual state of the at least one day comprises: determining a subset of days of the plurality of days based on an availability of data for the at least one specified type of industrial process; and determining a visual state for each day of the subset of days based on the comparison of the current environmental condition data to historic environment condition data for that day, wherein each visual state of the plurality of visual states is based on a differential between the current environmental condition data and the historic environment condition data.

Clause 4. The computer-implemented method of any of clauses 1-3, further comprising generating a plurality of visual representations from the plurality of visual states, wherein the plurality of visual states comprises a plurality of colors, and wherein each visual representation of the plurality of visual representations represents a different day of the plurality of days.

Clause 5. The computer-implemented method of any of clauses 1-4, further comprising modifying at least one process parameter for an industrial process based on the process data for the at least one day.

Clause 6. The computer-implemented method of any of clauses 1-5, further comprising controlling an ingredient addition device based on the at least one process parameter.

Clause 7. The computer-implemented method of any of clauses 1-6, wherein the graphical user interface comprising process data includes at least one graph showing a plurality of discrete instances of the industrial process according to at least one process parameter, the method further comprising: receiving a user selection of at least one discrete instance of the industrial process from the at least one graph; and generating a graphical user interface comprising process parameters for the at least one discrete instance of the industrial process.

Clause 8. A computer-implemented method of optimizing an industrial process based on at least one environmental parameter, comprising: receiving, with at least one processor, a specified type of industrial process; determining, with at least one processor, a plurality of days preceding a specified day for which process data associated with the specified type of industrial process is stored in a database; determining, with at least one processor, historic environment condition data for each day of the plurality of days; comparing, with at least one processor, current environmental condition data to the historic environment condition data for each of the plurality of days; determining, with at least one processor, a visual state from a plurality of visual states for each day of the plurality of days based on the comparison between the current environmental condition data and the historic environment condition data for each day; and generating, with at least one processor, a calendar interface comprising a plurality of visual representations, each visual representation corresponding to a day of the plurality of days and comprising the visual state determined for the corresponding day.

Clause 9. The computer-implemented method of clause 8, further comprising: receiving a user selection of at least one visual representation of the plurality of visual representations; and generating a graphical user interface comprising process data for at least one day corresponding to the at least one visual representation of the user selection, the process data including historical data for the specified type of industrial process.

Clause 10. The computer-implemented method of clause 8 or 9, further comprising determining, with at least one processor, the current environmental condition data for the specified day for a region in which the specified type of industrial process is being performed.

Clause 11. The computer-implemented method of any of clauses 8-10, wherein the plurality of visual states comprises a plurality of colors.

Clause 12. The computer-implemented method of any of clauses 8-11, further comprising modifying at least one process parameter for the specified type of industrial process based on the process data for the at least one day.

Clause 13. The computer-implemented method of any of clauses 8-12, further comprising controlling an ingredient addition device based on the at least one process parameter.

Clause 14. A computer-implemented method of optimizing an industrial process based on at least one environmental parameter, comprising: receiving, with at least one processor, a specified type of industrial process; determining, with at least one processor, a plurality of days preceding a specified day for which process data associated with the specified type of industrial process is stored in a database; determining, with at least one processor, historic environment condition data for each day of the plurality of days; comparing, with at least one processor, current environmental condition data to the historic environment condition data for each of the plurality of days; selecting, with at least one processor, at least one day of the plurality of days based on the comparison between the current environmental condition data and the historic environment condition data for each day of the plurality of days; retrieving, with at least one processor, process data corresponding to the at least one day from a database; and configuring process parameters for performing the industrial process based on the process data retrieved from the database.

Clause 15. The computer-implemented method of clause 14, further comprising: determining, with at least one processor and during performance of the specified type of industrial process, a change in the current environmental condition data; in response to determining the change, determining, with at least one processor, at least one different day of the plurality of days based on a comparison between the changed current environmental condition data and historic environment condition data for the at least one different day; and modifying, with at least one processor, at least one of the process parameters for the specified type of industrial process during performance of the specified type of industrial process.

Clause 16. A computer program product for optimizing an industrial process based on at least one environmental parameter comprising at least one non-transitory computer-readable medium including one or more instructions that, when executed by at least one processor, cause the at least one processor to: compare current environmental condition data to historic environment condition data for at least one day preceding a specified day; determine a visual state from a plurality of visual states for the at least one day based on the comparison between the current environmental condition data and the historic environment condition data; generate a calendar interface comprising a plurality of days preceding the specified day and corresponding to a plurality of visual representations, wherein at least one visual representation corresponding to the at least one day comprises the visual state; and in response to receiving a user selection of the at least one day of the plurality of days, generate a graphical user interface comprising process data for the at least one day, the process data including historical data for at least one type of industrial process.

Clause 17. The computer program product of clause 16, wherein the one or more instructions further cause the at least one processor to determine the current environmental condition data for the specified day for a region in which the at least one type of industrial process is being performed.

Clause 18. The computer program product of clause 16 or 17, wherein the one or more instructions that cause the at least one processor to determine the visual state of the at least one day cause the at least one processor to: determine a subset of days of the plurality of days based on an availability of data for the at least one specified type of industrial process; and determine a visual state for each day of the subset of days based on the comparison of the current environmental condition data to historic environment condition data for that day, wherein each visual state of the plurality of visual states is based on a differential between the current environmental condition data and the historic environment condition data.

Clause 19. The computer program product of any of clauses 16-18, wherein the one or more instructions further cause the at least one processor to generate a plurality of visual representations from the plurality of visual states, wherein the plurality of visual states comprises a plurality of colors, and wherein each visual representation of the plurality of visual representations represents a different day of the plurality of days.

Clause 20. The computer program product of any of clauses 16-19, wherein the one or more instructions further cause the at least one processor to modify at least one process parameter for an industrial process based on the process data for the at least one day.

Clause 21. The computer program product of any of clauses 16-20, wherein the one or more instructions further cause the at least one processor to control an ingredient addition device based on the at least one process parameter.

Clause 22. The computer program product of any of clauses 16-21, wherein the graphical user interface comprising process data includes at least one graph showing a plurality of discrete instances of the industrial process according to at least one process parameter, and wherein the one or more instructions further cause the at least one processor to: receive a user selection of at least one discrete instance of the industrial process from the at least one graph; and generate a graphical user interface comprising process parameters for the at least one discrete instance of the industrial process.

Clause 23. A system for optimizing an industrial process based on at least one environmental parameter, the system comprising at least one processor programmed and/or configured to: compare current environmental condition data to historic environment condition data for at least one day preceding a specified day; determine a visual state from a plurality of visual states for the at least one day based on the comparison between the current environmental condition data and the historic environment condition data; generate a calendar interface comprising a plurality of days preceding the specified day and corresponding to a plurality of visual representations, wherein at least one visual representation corresponding to the at least one day comprises the visual state; and in response to receiving a user selection of the at least one day of the plurality of days, generate a graphical user interface comprising process data for the at least one day, the process data including historical data for at least one type of industrial process.

Clause 24. The system of clause 23, wherein the at least one processor is further programmed and/or configured to determine the current environmental condition data for the specified day for a region in which the at least one type of industrial process is being performed.

Clause 25. The system of clause 23 or 24, wherein, when determining the visual state of the at least one day, the at least one processor is programmed and/or configured to: determine a subset of days of the plurality of days based on an availability of data for the at least one specified type of industrial process; and determine a visual state for each day of the subset of days based on the comparison of the current environmental condition data to historic environment condition data for that day, wherein each visual state of the plurality of visual states is based on a differential between the current environmental condition data and the historic environment condition data.

Clause 26. The system of any of clauses 23-25, wherein the at least one processor is further programmed and/or configured to generate a plurality of visual representations from the plurality of visual states, wherein the plurality of visual states comprises a plurality of colors, and wherein each visual representation of the plurality of visual representations represents a different day of the plurality of days.

Clause 27. The system of any of clauses 23-26, wherein the at least one processor is further programmed and/or configured to modify at least one process parameter for an industrial process based on the process data for the at least one day.

Clause 28. The system of any of clauses 23-27, wherein the at least one processor is further programmed and/or configured to control an ingredient addition device based on the at least one process parameter.

Clause 29. The system of any of clauses 23-28, wherein the graphical user interface comprising process data includes at least one graph showing a plurality of discrete instances of the industrial process according to at least one process parameter, and wherein the at least one processor is further programmed and/or configured to: receive a user selection of at least one discrete instance of the industrial process from the at least one graph; and generate a graphical user interface comprising process parameters for the at least one discrete instance of the industrial process.

Clause 30. A method of producing a chemical product from a reaction mixture containing at least two ingredients, comprising: generating, with at least one processor, at least one machine learning model configured to determine predicted reaction mixture data based on at least one input environmental parameter and at least one input product property, the predicted reaction mixture data comprising at least one of a composition of a reaction mixture and process conditions for a reaction mixture; training, with at least one processor, the at least one machine learning model based on a data set comprising data for a plurality of production instances of producing the chemical product, the data for each production instance comprising reaction mixture composition data, at least one environmental parameter for a production site of the chemical product, and at least one product property of the chemical product; determining, with at least one processor, the predicted reaction mixture data based on processing input data comprising a measured environmental parameter and at least one target product property according to the at least one machine learning model; producing the chemical product based on the predicted reaction mixture data; obtaining at least one measured product property of the chemical product produced based on the predicted reaction mixture data; and modifying, with at least one processor, the at least one model based on the at least one measured product property and the predicted reaction mixture data.

Clause 31. The method of clause 30, further comprising: prior to training the at least one machine learning model, removing, with at least one processor, outliers from the data set based on a statistical algorithm.

Clause 32. The method of clause 30 or 31, further comprising receiving, via a graphical user interface, at least one of the at least one measured environmental parameter and the at least one target product property.

Clause 33. The method of any of clauses 30 to 32, further comprising displaying, on a graphical user interface, the predicted reaction mixture data.

Clause 34. The method of any of clauses 30 to 33, wherein the at least one target product property comprises at least two target product properties.

Clause 35. The method of any of clauses 30 to 34, wherein the at least one measured environmental parameter comprises at least two measured environmental parameters.

Clause 36. The method of any of clauses 30 to 35, wherein the at least one measured environmental parameter comprises at least one of the following: an air pressure, an air temperature, an air relative humidity, or combinations thereof.

Clause 37. The method of any of clauses 30 to 36, wherein the at least one target product property is at least one of a raw density according to DIN EN ISO 845 and a compression load deflection at 40% compression according to EN ISO 3386.

Clause 38. The method of any of clauses 30 to 37, wherein the chemical product comprises a polyurethane foam, and wherein the reaction mixture comprises: a polyisocyanate; a polyisocyanate-reactive compound; a blowing agent; or combinations thereof; and optionally water.

Clause 39. The method of any of clauses 30 to 38, wherein determining the predicted reaction mixture data comprises: modifying a predetermined mixture composition by adjusting at least one of: a molar ratio of isocyanate groups to isocyanate-reactive groups; an amount of blowing agent; an amount of physical blowing agent relative to an amount of chemical blowing agent; or combinations thereof.

Clause 40. The method of any of clauses 30 to 39, further comprising: while producing the chemical product based on the predicted reaction mixture, receiving an updated measured environmental parameter from the production site of the chemical product; and updating, with at least one processor, the predicted reaction mixture data based on the updated measured environmental parameter.

Clause 41. The method of any of clauses 30 to 40, wherein updating the predicted reaction mixture data based on the updated measured environmental parameter comprises adjusting at least one of the composition of the reaction mixture and process conditions for the reaction mixture.

Clause 42. The method of any of clauses 30 to 41, further comprising while producing the chemical product based on the predicted reaction mixture, receiving an updated measured environmental parameter from the production site of the chemical product; and determining not to adjust the predicted reaction mixture data based on the updated measured environmental parameter.

Clause 43. The method of any of clauses 30 to 42, further comprising: determining, with at least one processor, that the updated measured environmental parameter is different than the measured environmental parameter, adjusting, with at least one processor, at least one of the composition of the reaction mixture and process conditions for the reaction mixture in response to the determination that the updated measured environmental parameter is different than the measured environmental parameter.

Clause 44. The method of any of clauses 30 to 43, wherein receiving an updated measured environmental parameter comprises receiving at least two updated measured environmental parameters.

These and other features and characteristics of the present invention, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and the claims, the singular form of “a,” “an,” and “the” include plural referents unless the context clearly dictates otherwise.

### BRIEF DESCRIPTION OF THE DRAWINGS

FIG. 1 is a schematic view of a system for optimizing an industrial process in accordance with non-limiting embodiments;

FIGS. 2-4 are process flow diagrams of methods for optimizing an industrial process in accordance with non-limiting embodiments;

FIG. 5 is a schematic view of a calendar interface generated during the method of FIG. 2 or 3;

FIGS. 6a-6c are schematic views of various graphical user interfaces generated during the method of FIG. 2 or 3;

FIG. 7 is a schematic view of process data stored in a database in accordance with non-limiting embodiments;

FIG. 8 is a process flow diagram of a method of producing a chemical product in accordance with non-limiting embodiments; and

FIG. 9 is a schematic diagram of components of a device used in accordance with non-limiting embodiments.

### DETAILED DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the invention as it is oriented in the drawing figures. However, it is to be understood that the invention may assume various alternative variations and step sequences, except where expressly specified to the contrary. It is also to be understood that the specific devices and processes illustrated in the attached drawings, and described in the following specification, are simply exemplary embodiments or aspects. Hence, specific dimensions and other physical characteristics related to the embodiments or aspects disclosed herein are not to be considered as limiting.

As used herein, the terms “communication” and “communicate” may refer to the reception, receipt, transmission, transfer, provision, and/or the like, of information (e.g., data, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and communicates the processed information to the second unit. In some non-limiting embodiments, a message may refer to a network packet (e.g., a data packet, and/or the like) that includes data. It will be appreciated that numerous other arrangements are possible.

As used herein, the term “computing device” may refer to one or more electronic devices configured to process data. A computing device may, in some examples, include the necessary components to receive, process, and output data, such as a processor, a display, a memory, an input device, a network interface, and/or the like. A computing device may be a mobile device. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. A computing device may also be a desktop computer, server, or other form of non-mobile computer.

As used herein, the term “user interface” or “graphical user interface” refers to a generated display, such as one or more graphical user interfaces (GUIs) with which a user may interact, either directly or indirectly (e.g., through a keyboard, mouse, touchscreen, etc.).

As used herein, the term “application programming interface” (API) may refer to computer code that allows communication between different systems or (hardware and/or software) components of systems. For example, an API may include function calls, functions, subroutines, communication protocols, fields, and/or the like usable and/or accessible by other systems or other (hardware and/or software) components of systems.

As used herein, the term “industrial process” may refer to a process for manufacturing a product. An industrial process may include adding one or more ingredients to a mixture, mixing of one or more ingredients, adding one or more catalysts to the mixture, heating the mixture, conveying the mixture, and/or the like. In some non-limiting embodiments, the industrial process may be a foam manufacturing process, such as a polyurethane foam manufacturing process. The mixture may be a reaction mixture in which two or more ingredients are chemically reacted with one another to produce a chemical product.

As used herein, the term “process data” may refer to data obtained before, after, or during performance of an industrial process. Process data may include data related to historic environment conditions (e.g. temperature, barometric pressure, relative and/or absolute humidity, grains of moisture, and/or the like) observed or measured during past performance of the industrial process. Process data may also include data related to one or more properties of materials (e.g. density, IFD hardness, chemical composition, and/or the like) produced during past performance of the industrial process. Process data may also include data related to one or more process parameters of the industrial process (e.g. ingredient flow rate, ingredient temperature, relative ingredient ratios, catalyst addition, heating parameters, mixing parameters, conveying speed and/or the like) during past performance of the industrial process.

As used herein, the term “product property” may refer to a physical or chemical characteristic of a product. Non-limiting examples of product properties may include density, such as a raw density according to DIN EN ISO 845; an IFD hardness; a load deflection, such as a compression load deflection at 40% compression according to EN ISO 3386; a chemical composition of the product; a reactivity; and/or the like.

As used herein, the term “environmental parameter” may refer to an environmental or climate condition of a location or facility, such as a production site for a chemical product. Non-limiting examples of environmental parameters may include an air temperature; a heat index, an air pressure, a relative and/or absolute humidity, and/or the like. Environmental parameters may be expressed by any conventional measurement techniques. For example, humidity may be expressed in terms of grains of moisture.

As used herein, the term “machine learning algorithm” may refer to an algorithm for applying at least one predictive model to a data set. A machine learning algorithm may train at least one predictive model through expansion of the data set by continually or intermittently updating the data set with results of instances of an industrial process. Examples of machine learning algorithms may include supervised and/or unsupervised techniques such as decision trees, gradient boosting, logistic regression, artificial neural networks, Bayesian statistics, learning automata, Hidden Markov Modeling, linear classifiers, quadratic classifiers, association rule learning, or the like. As used herein, the term “machine learning model” may refer to a predictive model at least partially generated by a machine learning algorithm.

Non-limiting embodiments or aspects of the present disclosure are directed to methods, systems, and computer program products for optimizing an industrial process. The various non-limiting embodiments described herein facilitate comparison of current environmental condition data to historic environment condition data and, based on that comparison, optimize the industrial process. Described embodiments improve upon conventional methods by configuring and/or modifying process parameters of the industrial process based on categorized empirical data from past performances of the industrial process. Disclosed embodiments result in industrial processes which create consistent, repeatable results without relying on the uncertainties of human operator skill and experience. Additionally, disclosed embodiments reduce the need for on-the-fly adjustments necessitated by less than optimal initial configuration of the industrial process. In some embodiments, the use of catalysts, reagents, or other industrial process ingredients conventionally used to mitigate error and/or uncertainty in performance of the industrial process may be reduced as a consequence of the optimized process parameters. In some non-limiting embodiments, one or more user interfaces are generated which allow a user to select at least one day from a plurality of days preceding a specified day. In some non-limiting embodiments, the industrial process is modified based on process data for the at least one day selected by the user. In some non-limiting embodiments, the industrial process is automatically modified based on process data associated with at least one day preceding the specified day, based on the comparison of current environmental condition data to historic environment condition data. As such, the operator may have ultimate control of the process but may be assisted in configuration and/or modification of the process parameters to reduce the prevalence of operator miscalculations and/or estimations of suitable process parameters. In some non-limiting embodiments, the industrial process is automatically modified according to at least one machine learning model in order to produce a product having at least one target property. The at least one machine learning model may predict reaction mixture composition data for the industrial process based on the target property and at least one environmental parameter. The at least one machine learning algorithm may be continuously or periodically retrained by expanding an underlying data set to include measurements obtained from production instances of the industrial process. All of the foregoing improvements result in an industrial process which creates a product having desirable finished characteristics with greater accuracy, improved reliably, and less component waste.

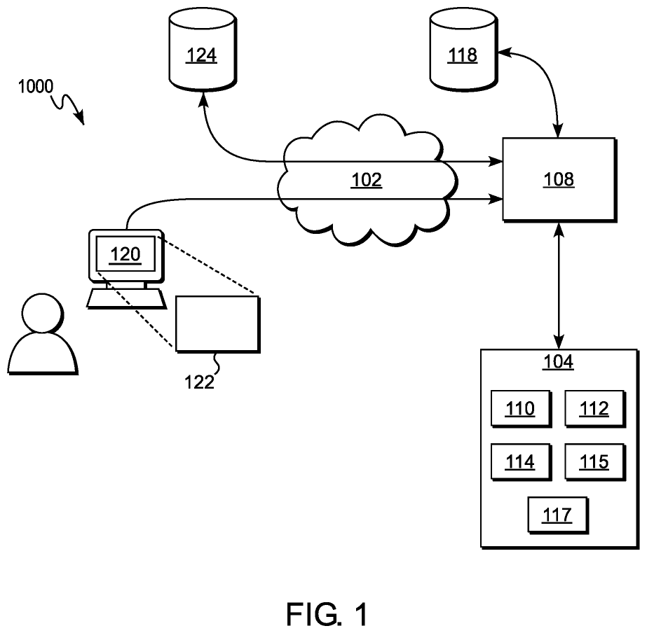

Referring now to FIG. 1, a system 1000 for performing an industrial process is shown according to a non-limiting embodiment. The system 1000 includes a network environment 102 through which one or more industrial devices 104 are in communication with a server computer 108. The server computer 108 may include a computing device including at least one processor programmed or configured to perform a function by executing software instructions stored on a non-transitory computer-readable medium. The network environment 102 may be a local area network (LAN), a wide area network (WAN), a public network (e.g., the Internet or other public network), and/or a private network.

The one or more industrial devices 104 may include one or more modules configured to perform various operations of the industrial process. In non-limiting embodiments, the one or more modules of the one or more industrial devices 104 may include one or more ingredient addition devices 110, one or more mixing devices 112, one or more conveying devices 114, and/or one or more heating devices 116. The one or more industrial devices may include a computing device such as at least one processor programmed or configured to perform a function by executing software instructions stored on a non-transitory computer-readable medium. For example, the at least one processor may be programmed or configured to implement at least one process parameter for controlling the one or more modules. In some non-limiting embodiments, the process parameters may include, for example, ingredient flow rate and/or ingredient temperature controlled by the one or more ingredient addition devices 110 and/or the one or more heating devices 116. Process parameters may also include conveying speed controlled by the one or more conveying devices 114.

The one or more industrial devices 104 may further include one or more process data sensors 117 for measuring and/or gathering process data prior to, during, and/or after performance of the industrial process. The one or more process data sensors 117 may include one or more barometers, thermometers, hydrometers, psychrometers, and/or the like. In non-limiting embodiments, the one or more process data sensors 117 may be configured to measure current environmental condition data, such as temperature, relative and absolute humidity, pressure, grains of moisture, and/or the like, in a region in which the one or more industrial devices 104 performs an industrial process. In non-limiting embodiments, the one or more process data sensors 117 may be configured to gather process parameter data during performance of the industrial process, such as ingredient flow rate, ingredient temperature, conveying speed, and/or the like.

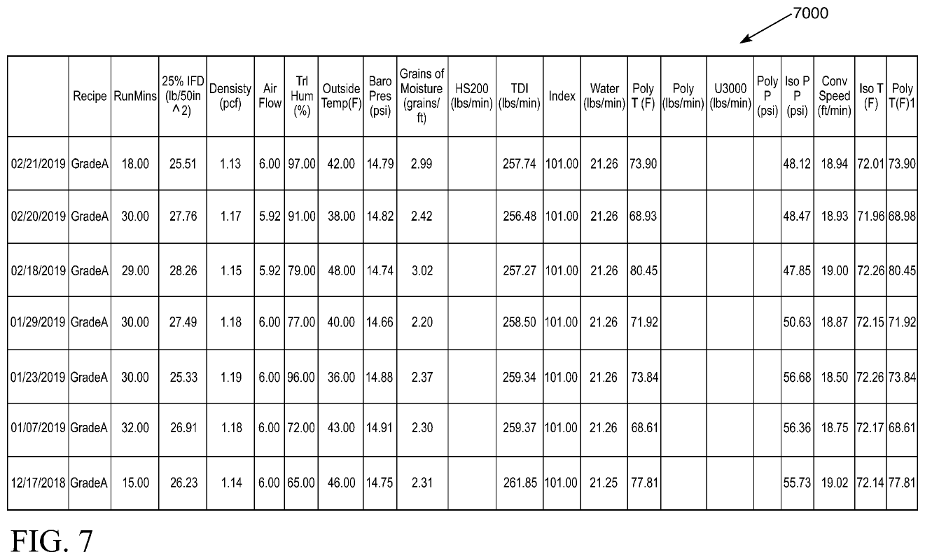

The process data measured and/or gathered by the one or more process data sensors 117 may be communicated to the server computer 108 via the network 102. The process data may be communicated in real-time, at predefined intervals, in batches, and/or in any other like manner. In some examples, the process data communicated to the server computer 108 may include raw sensor data. In other examples, the process data communicated to the server computer 108 may be generated from processed sensor data. The process data may also include a combination of raw and processed sensor data. The server computer 108, in response to receiving process data during performance of the industrial process, may store the process data in a historic process data database 118. The historic process data database 118 may be a secure, read-only database that prevents users from modifying the process data after it has been stored. An example of a table of process data stored in the historic process data database 118 is shown in FIG. 7

With continued reference to FIG. 1, in non-limiting embodiments a client device 120 may be in communication with the server computer 108 via the network 102. The client device 120 may be a computing device configured to communicate with the network 102. The client device 120 may include at least one processor programmed or configured to perform a function by executing software instructions stored on a non-transitory computer-readable medium. The client device 120 may display one or more graphical user interfaces (GUIs) 122 to allow a user to interact with the server computer 108. In some examples, the one or more GUIs 122 may be a web-based portal through which the user logs-in with user credentials, such as a user name and password. The one or more GUIs 122 may also be a standalone software application. Through the one or more GUIs 122, the user may view the process data stored in the historic process data database 118, generate additional GUIs 122 based on selection of particular process data, and/or modify one or more process parameters of the industrial process based on selection of particular process data.

With continued reference to FIG. 1, in some non-limiting embodiments, a third party database 124 may be in communication with the server computer 108 via the network 102. The third party database 124 may include supplemental data not directly gathered from the one or more process data sensors 117. For example, in some non-limiting embodiments the one or more process data sensors 117 do not measure or gather real-time or current environmental condition data (e.g. temperature, barometric pressure, relative and/or absolute humidity, grains of moisture, and/or the like). In such non-limiting embodiments, the server computer 108 may be configured to retrieve current environmental condition data from the third party database 124 prior to or concurrently with performance of the industrial process. In some embodiments, the third party database 124 may be utilized to verify the current environmental condition data measured or observed by the one or more process data sensors 117, or may be combined with the measured data. The third-party database 124 may be a part of a third party system queried through an API, such as a government or private data service.

With continued reference to FIG. 1, the system 1000 may facilitate optimization of the industrial process according to the non-limiting embodiments discussed herein. Generally, the system 1000 optimizes the industrial process via a computer-implemented method in which the current environmental condition data is compared to historical environment condition data stored in the historic process data database 118 in order to configure and/or modify at least one process parameter of a specified type of industrial process. In non-limiting embodiments, the industrial process is optimized via a computer-implemented method in which the current environmental condition data is compared to historical environment condition data stored in the historic process data database 118 such that past days with the highest environmental similarity are chosen as benchmarks for a machine-learning model to predict optimal reaction mixture composition and process conditions to configure and/or modify at least one process parameter of a specified type of industrial process. In non-limiting embodiments, the current environmental condition data is compared to historical environment condition data for a plurality of days on which a past industrial process, the same or similar to the specified type of industrial process, was performed. At least one day of the plurality of days may be selected based on the comparison of current environmental condition data to historical environment condition data. In some non-limiting embodiments, the selected at least one day may be the day of the plurality of days having the closest historical environment condition data to the current environmental condition data. In some embodiments, the at least one process parameter of the specified type of industrial process may be modified to replicate or at least partially replicate a similar process parameter of the past industrial process performed on the selected day.

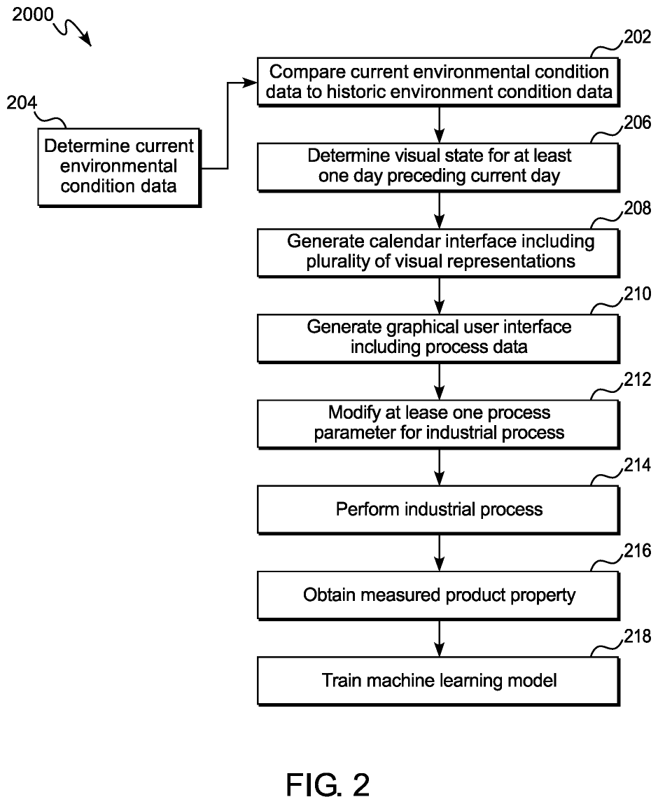

More particular non-limiting embodiments of the method for optimizing the industrial process will now be described with reference to FIGS. 2-4. In further non-limiting embodiments, a computer program product for optimizing an industrial process includes at least one non-transitory computer readable medium including program instructions that, when executed by at least one processor, cause at least one processor to execute any of the methods described herein with reference to FIGS. 2-4.

Referring now to FIG. 2, a flow diagram for a method 2000 of optimizing an industrial process is shown in accordance with a non-limiting embodiment of the present disclosure. At step 202, the method 2000 includes comparing current environmental condition data to historic environment condition data for at least one day preceding a specified day. In some non-limiting embodiments, the specified day may be the current day or a day in the future. In some non-limiting embodiments, the at least one day preceding the specified day may include a plurality of days for which historic environment condition data is stored as process data in the historic process data database 118. The historic environment condition data for the at least one day may be retrieved from the historic process data database 118 by at least one processor of the client device 120 or by at least one processor of the server computer 108. The historic environment condition data for each day preceding the specified day may include, for example, temperature, relative and/or absolute humidity, barometric pressure, grains of moisture, and/or the like. The comparison of the current environmental condition data to historic environment condition data may be performed by at least one processor of the client device 120 or by at least one processor of the server computer 108.

In some non-limiting embodiments, step 202 may be preceded by step 204, in which current environmental condition data is determined for the specified day in a region in which at least one type of industrial process is being performed. For example, the current environmental condition data may be determined by receiving and/or aggregating measurement data from one or more process data sensors 117. In other embodiments, the current environmental condition data for the specified day may be acquired from the third party database 124. As noted above, the current environmental condition data for the specified day may include, for example, temperature, relative and/or absolute humidity, barometric pressure, grains of moisture, and/or the like. Determination of the current environmental condition data may be performed by at least one processor of the client device 120 or by at least one processor of the server computer 108.

With continued reference to FIG. 2, at step 206, a visual state is determined for the at least one day preceding the specified day, based on the comparison between the current environmental condition data and the historic environment condition data performed at step 202. The visual state may be selected from a plurality of visual states, and may indicate a relative differential between the current environmental condition data and the historic environment condition data. For example, the plurality of visual states may include a first visual state indicating that the current environmental condition data is within a predetermined differential from the historic environment condition data, and a second visual state indicating that the current environmental condition data is outside the predetermined differential from the historic environment condition data.

In some non-limiting embodiments, the plurality of visual states may include a range of states indicating the differential between the current environmental condition data and the historic environment condition data for each of the plurality of days preceding the specified day. For example, the plurality of visual states may include a plurality of colors, with a first color indicating a differential within a first range (e.g. within 20% of the current environmental condition data), a second color indicating a differential within a second range (e.g. within 40% of the current environmental condition data), a third color indicating a differential with a third range (e.g. within 60% of the current environmental condition data), and so on. The visual state for each of the plurality of days preceding the specified day may thus assist the user of the client device 120, at least one processor of the client device 120, and/or at least one processor of the server computer 108 in identifying the relative differential between the current environmental condition data for the specified day and the historic environment condition data of each of the plurality of days preceding the specified day. For example, if the visual state of a first day of the plurality of days preceding the specified day includes the first color, the historic environment condition data of the first day may have a lesser differential to the current environmental condition data of the specified day than a second day of the plurality of days preceding the specified day which has a visual state including the second color.

It is to be understood that, although colors are specifically discussed herein as examples of visual states, the visual states may also be represented as symbols, tokens, typeface or font attributes, shading, highlighting, cross-hatching, and/or the like.

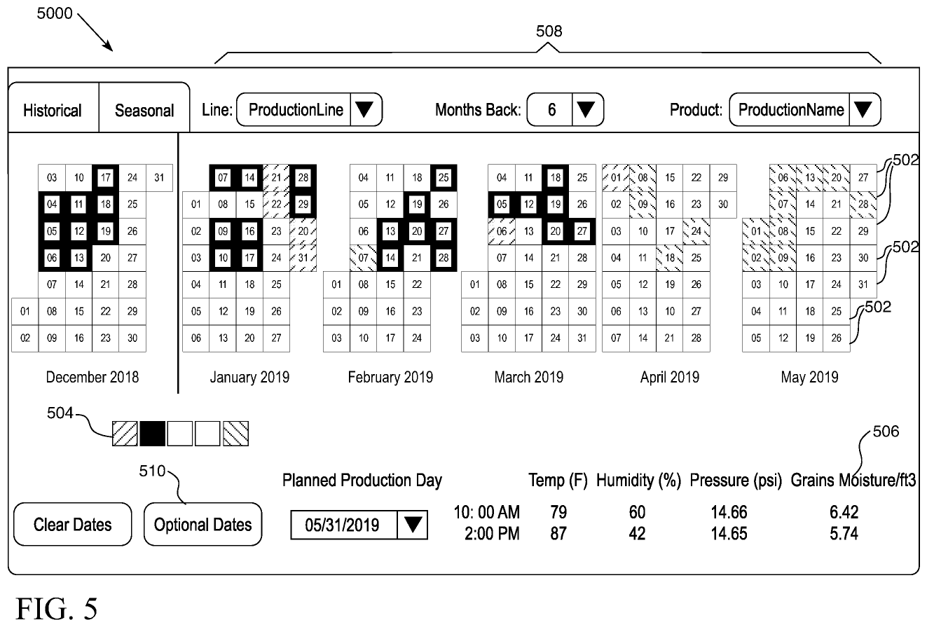

With continued reference to FIG. 2, at step 208, a calendar interface is generated and displayed as the GUI 122 on the client device 120. Referring to FIG. 5, an example of a calendar interface 5000 generated at step 208 is shown. The calendar interface 5000 may include a plurality of visual representations 502. Each of the plurality of visual representations 502 may correspond to one or more days of the plurality of days preceding the specified day. In the non-limiting embodiment shown in FIG. 5, the plurality of visual representations 502 includes tiles or blocks corresponding to each day in December 2016, January 2017, February 2017, December 2017, January 2018, February 2018, December 2018, January 2019, and February 2019. Although FIG. 5 shows the plurality of visual representations 502 presented in a calendar arrangement, the plurality of visual representations 502 may also be presented as a list, drop down menu, or the like. Each of the plurality of visual representations 502 may include the visual state(s) determined for the corresponding day preceding the specified day as determined at step 206. In the non-limiting embodiment shown in FIG. 5, the visual state of each of the plurality of visual representations 502 is selected from a plurality of colors, as indicated in the legend 504. The plurality of colors indicates a relative differential between the historic environment condition data of the each of the plurality of days preceding the specified day and the current environmental condition data of the specified day, as described herein with reference to step 206. For example, the visual representation 502 for Dec. 17, 2018 has a first visual state of the first color (e.g. dark green), while the visual representation 502 for Dec. 21, 2018 has a third visual state of the third color (e.g. yellow.) As such, the user of the client device 120 may understand that the historic environment condition data for Dec. 21, 2018 deviates more from the current environmental condition data of the specified day than does the historic environment condition data for Dec. 17, 2018. Similarly, the visual representation 502 for Jan. 31, 2019 has a fifth visual state of a fifth color (e.g. dark red), indicating that the historic environment condition data from that day deviates from the current environmental condition data of the specified day more than the historic environment condition data for Dec. 21, 2018. The visual representations 502 corresponding to days for which historic environment condition data is unavailable, e.g. for which no or insufficient process data is stored in the historic process data database 118 or for which no information was communicated from the server computer 108 to the one or more industrial devices 104, may have a visual state of a default color (e.g. gray as shown in FIG. 5) or absence of a visual state.

As may be further appreciated from FIG. 5, the calendar interface 5000 may include a current conditions display region 506 which displays the current environmental condition data of the specified day. The current environmental condition data may be retrieved as described herein with reference to the step 204. The calendar interface 5000 may further include at least one sort and/or filter field 508 which allows the user to manipulate the presentation of the plurality of visual representations 502. For example, the at least one sort and/or filter fields 508 may allow the user to select arrange of months for which to display visual representations 502. In the non-limiting embodiment shown in FIG. 5, a range of six months is selected, such that the visual representations 502 are shown for days in the months of December through May while no visual representations are shown for days in the months of June through November.

With continued reference to FIG. 5, at least one of the visual representations 502 is selectable by the user via a user input device of the client device 120. In some non-limiting embodiments, only the visual representations 502 corresponding to days for which historic environment condition data is stored in the historic process data database 118 are selectable by the user. Visual representations 502 corresponding to days for which historic environment condition data is unavailable, e.g., those visual representations having a visual state of gray in FIG. 5, may not be selectable by the user. In some non-limiting embodiments, the calendar interface 5000 may include an optimal selection field 510 which, when activated by the user, automatically selects an optimal day or days from among the plurality of visual representations 502. In particular, selection of the optimal selection field 510 causes at least one processor of the client device 120 or at least one processor of the server computer 108 to automatically select the visual representation(s) 502 which correspond to days having historic environment condition data having the least differential relative to the current environmental condition data of the specified day. Selection of the optimal selection field 510 may also cause at least one processor of the client device 120 or at least one processor of the server computer 108 to automatically generate and display a GUI presenting process data associated with the optimal day or days, such GUI 6000a which will be described in greater detail herein.

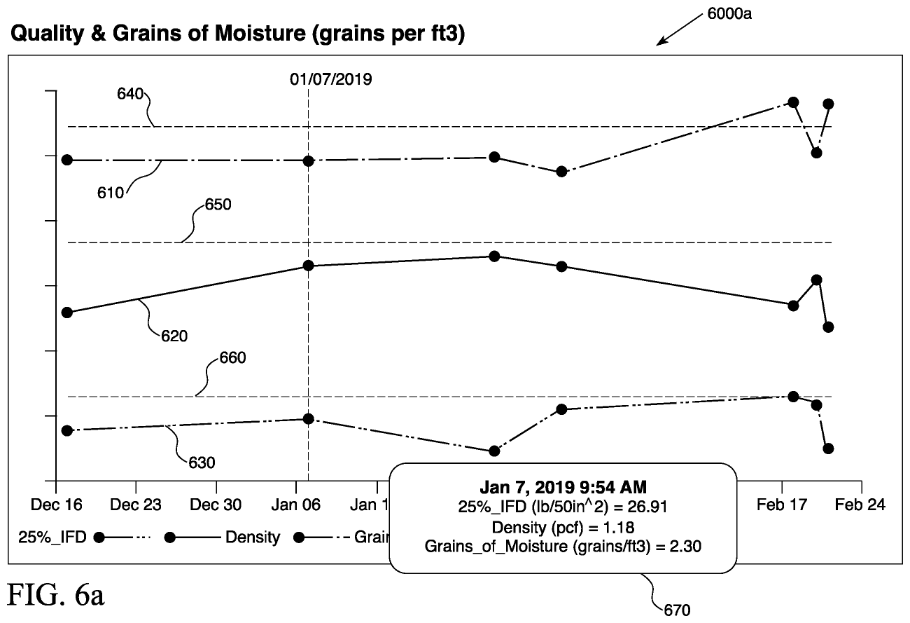

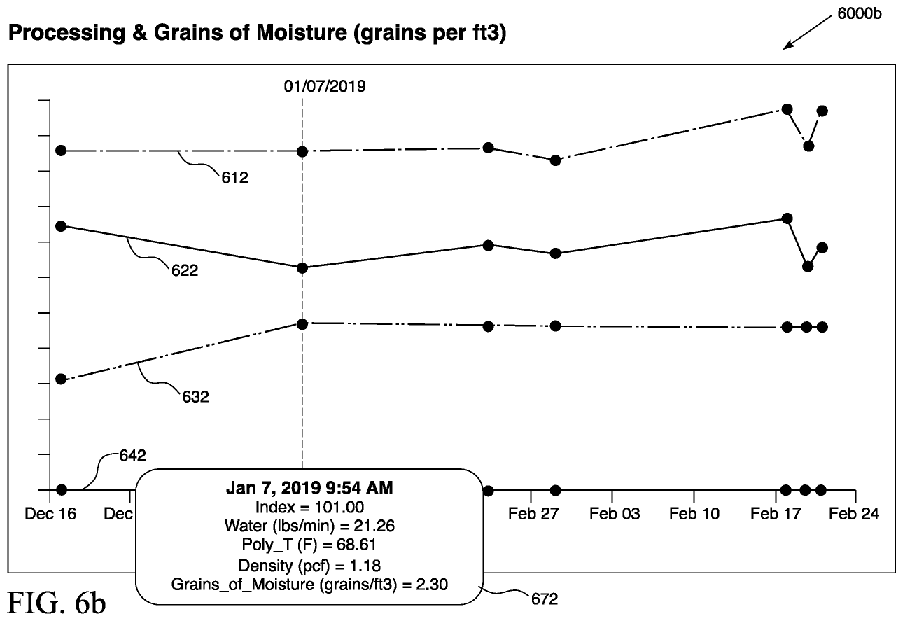

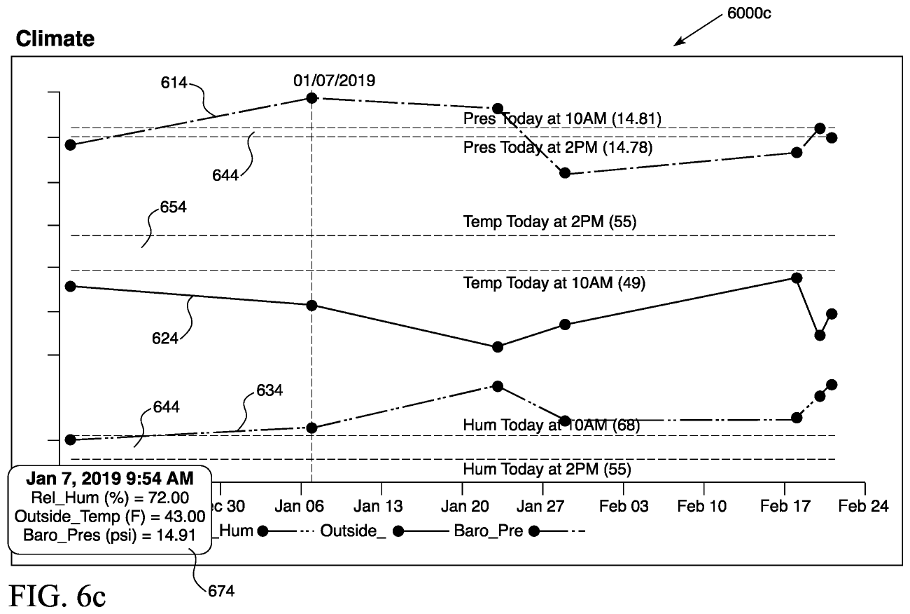

Referring again to FIG. 2, at step 210, at least one GUI including process data for at least one day of the plurality of days preceding the specified day is generated in response to the user selection, or automatic selection by at least one processor, of at least one visual representation 502 from the calendar interface 5000. The visual representation 502 selected from the calendar interface 5000 may be selected based on the differential between the current environmental conditions and the historic environment conditions of the plurality of days preceding the specified day. For example, the user may select one or more visual representations 502 corresponding to one or more days having a smallest differential of the plurality of days. The at least one GUI generated at step 210 is displayed as the GUI 122 of the client device 120. Referring to FIGS. 6a-6c, various examples of GUIs 6000a, 6000b, 6000c generated at step 210 are shown. The GUIs 6000a, 6000b, 6000c may include one or more graphical representations of process data related to historic environment condition data and/or historical product property data of a product produced by a past performance of the industrial process. The process data may be retrieved from the historical process database 118. In the non-limiting example shown in FIG. 6a, the GUI 6000a includes a graphical representation 610 of historic grains of moisture process data for the plurality of days preceding the specified day, a graphical representation 620 of density of a product produced by the industrial process for the plurality of days preceding the specified day, and a graphical representation 630 of indentation force deflection (IFD) firmness of the product produced by the industrial process for the plurality of days preceding the specified day. The grains of moisture, density, and IFD hardness corresponding to each of the plurality of days preceding the specified day may be graphically represented by one or more data points of the graphical representations 610, 620, 630. The user may select, via hovering over, the one or more data points associated with a particular day of the plurality of days to view the specific process data related to that particular day. For example, FIG. 6a shows the selection of data points corresponding to the particular day of Jan. 7, 2019. The process data for Jan. 7, 2019 is thus populated and displayed in an information module 670 of the GUI 6000a. For the day of Jan. 7, 2019, the process data includes a grains of moisture of 2.30 grains per cubic foot (grains/ft3), a product density of 1.18 pounds per cubic foot (pcf), and a product 25% IFD hardness of 26.91 pounds per fifty square inches (lb/50 in\hat{ }2). Selection of the one or more data points associated with a particular day of the plurality of days may generate a table such as shown in FIG. 7 displaying process data associated with the selected data points.

With continued reference to FIG. 6a, the GUI 6000a may further include one or more graphical representations 640 of current environmental condition data overlaid with the historic environment condition data. In the non-limited example shown in FIG. 6a, the graphical representation 640 of current environmental condition data includes grains of moisture data for the specified day (e.g. 2.7 grains/ft3 at 10 AM and 2.69 grains/ft3 at 2 PM, as shown in FIG. 6a) overlaid with the graphical representation 610 of historic grains of moisture process data for the plurality of days preceding the specified day.

The GUI 6000a may further include one or more graphical representations 650, 660 of predetermined target product properties overlaid with the historical product property data. In the non-limited example shown in FIG. 6a, the graphical representation 650 includes a target product density (e.g. 1.2 pcf) and the graphical representation 660 includes a target product IFD hardness (e.g. 28 lb/50 in\hat{ }2). The graphical representation 650 is overlaid with the graphical representation 620 of historic density of the product associated with the plurality of days preceding the specified day, and the graphical representation 660 is overlaid with the graphical representation 630 of historic IFD hardness of the product associated with the plurality of days preceding the specified day.

Referring now to FIG. 6b, another non-limiting embodiment of a GUI 6000b generated at step 210 is shown. Similar to the GUI 6000a of FIG. 6a, the GUI 6000b includes one or more graphical representations 612, 622, 632, 642 of process data related to historic environment condition data and/or historical product property data of a product to be produced by the industrial process for the plurality of days preceding the specified day. The process data may be retrieved from the historical process database 118. In particular, the graphical representation 612 includes historic index data (e.g. a ratio of NCO to OH functional groups, where an index of 100 means a 1:1 ratio of NCO to OH) for the plurality of days preceding the specified day. The graphical representation 622 includes historic water flow rate data for the industrial process for the plurality of days preceding the specified day, the graphical representation 632 includes historic polyurethane temperature data for the industrial process for the plurality of days preceding the specified day, and the graphical representation 642 includes grains of moisture data for the plurality of days preceding the specified day. The user may select, via hovering over, the one or more data points associated with a particular day of the plurality of days to view the specific process data related to that particular day in the information module 672. Selection of the one or more data points associated with a particular day of the plurality of days may generate a table such as shown in FIG. 7 displaying process data associated with the selected data points.

Referring now to FIG. 6c, another non-limiting embodiment of a GUI 6000c generated at step 210 is shown. Similar to the GUI 6000a of FIG. 6a, the GUI 6000c includes one or more graphical representations 614, 624, 634 of process data including historic environment condition data for the plurality of days preceding the specified day. The process data may be retrieved from the historical process database 118. The GUI 6000c further includes one or more graphical representations 644, 654, 664 of current environmental condition data overlaying the graphical representations 614, 624, 634. In particular, the graphical representation 614 includes relative humidity data for the plurality of days preceding the specified day, and is overlaid by the graphical representation 644 including relative humidity data for the specified day. The graphical representation 624 includes outside temperature data for the plurality of days preceding the specified day, and is overlaid by the graphical representation 654 including outside temperature data for the specified day. The graphical representation 624 includes barometric pressure data for the plurality of days preceding the specified day, and is overlaid by the graphical representation 664 including barometric pressure data for the specified day. The user may select, via hovering over, the one or more data points associated with a particular day of the plurality of days to view the specific process data related to that particular day in the information module 674. Selection of the one or more data points associated with a particular day of the plurality of days may generate a table such as shown in FIG. 7 displaying process data associated with the selected data points.

Referring again to FIG. 2, non-limiting embodiments of the method 2000 may further include, at step 212, modifying at least one process parameter of the industrial process based on the process data for the at least one day selected at step 210. In some non-limiting embodiments, the at least one process parameter may include operating parameters of the one or more industrial devices 104, such as ingredient flow rate and/or ingredient temperature controlled by the one or more ingredient addition devices 110 and conveying speed controlled by the one or more conveying devices 114. Prior to modification of at least one process parameter at step 212, the process parameters of the industrial process may be optimized for standard or default environmental conditions. Modification of the at least one process parameter at step 212 facilitates production of a product having desired finished properties (e.g. density and/or IFD hardness) when the current environmental conditions deviate from the standard or default environmental conditions. Specifically, the at least one process parameter may be modified to replicate an analogous process parameter from a past performance of the industrial process performed under similar environmental conditions to the current environmental conditions. In some embodiments, the at least one process parameter may be modified to match at least a portion of the process data stored in the historic process data database 118 for the at least one day selected at step 210. For example, the at least one process parameters may include water flow rate and polyurethane temperature, and the at least one day selected at step 210 may by Jan. 7, 2019. At least one processor of the client device 120 and/or at least one processor of the server computer 108 may modify the process parameters of the industrial process to match those from Jan. 7, 2019. Specifically, at least one processor of the client device 120 and/or at least one processor of the server computer 108 retrieves process data associated with Jan. 7, 2019 from the historic process data database 118 and modifies the at least one process parameter to match the retrieved process data. As shown in FIG. 7, the process data associated with Jan. 7, 2019 includes a water flow rate of 21.26 lbs/min and a polyurethane temperature of 68.1° F. Accordingly, the at least one process parameter of the industrial process may be modified to have a water flow rate of 21.26 lbs/min and a polyurethane temperature of 68.1° F., matching the process data for Jan. 7, 2019.

In some non-limiting embodiments, at least one processor of the client device 120 and/or at least one processor of the server computer 108 may interpolate or extrapolate from the process data of the at least one day selected at step 210 to modify the at least one process parameter based on a differential between the current environmental condition data and the historic environment condition data associated with the at least one day selected at step 210. For example, if the current environmental condition data includes a different value for grains of moisture than the grains of moisture of the selected at least one day, at least one processor of the client device 120 and/or at least one processor of the server computer 108 may modify the at least one process parameter to deviate from the process data associated with the selected day in order to account for the difference in grains of moisture. In some non-limiting embodiments, modification of at least one process parameter may be based on at least one machine learning algorithm trained from a data set including process data associated with past performances of the process. The data set may be updated, and the machine learning model re-trained, with process data from additional performances of the process to improve predictive accuracy. The data set may be updated on a periodic basis, e.g. daily or weekly, with process data from performances having occurred since the last update.

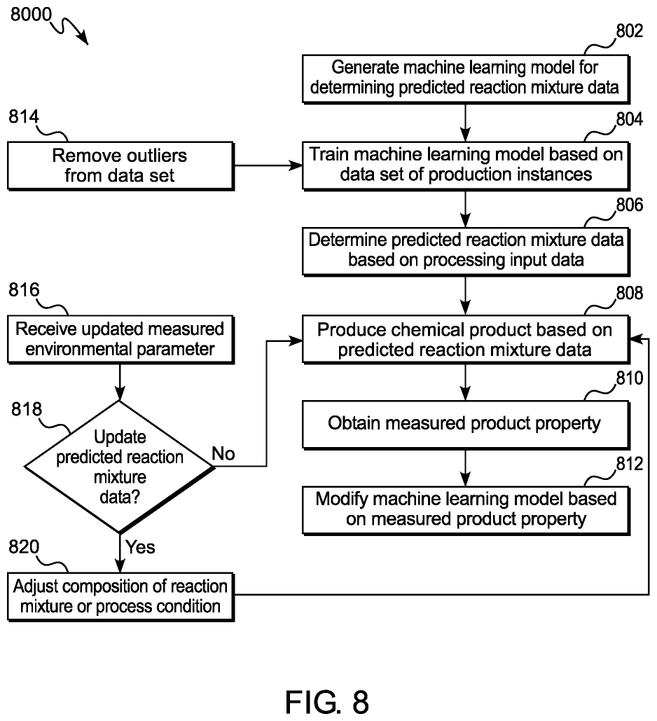

In some non-limiting embodiments, at least one processor of the client device 120 and/or at least one processor of the server computer 108 may modify the at least one process parameter in a manner which deviates from the process data associated with the selected day in order to change a product property of the product produced from the industrial process. For example, the day selected at step 210 may be Jan. 7, 2019 which produced a product having a 25% IFD hardness of 26.91 lb/50 in\hat{ }2 (as shown in FIG. 7). However, the user may input into the client device 120 a target 25% IFD hardness of more or less than 26.91 lb/50 in\hat{ }2. At least one processor of the client device 120 and/or at least one processor of the server computer 108 may modify the at least one process parameter based on the process data associated with Jan. 7, 2019 (e.g. water flow rate of 21.26 lbs/min and a polyurethane temperature of 68.1° F.), but may further modify the at least one process parameter in order to produce a product having the target 25% IFD hardness. That is, the process data associated with Jan. 7, 2019 may be used as a baseline for modifying the at least one process parameter, but the final modification to the at least one process parameter may be deviated from the process data associated with Jan. 7, 2019 in order to produce the target product property. In some non-limiting embodiments, at least one processor of the client device 120 and/or at least one processor of the server computer 108 may utilize one or more machine learning algorithms, based on a plurality of previous performances of the industrial process, to determine the degree to which the at least one process parameter should be modified to attain the target product property. Non-limiting embodiments of machine learning algorithms and machine learning models for modifying at least one process parameter are described in greater detail herein with reference to FIG. 8 and the associated description of the method 8000.

Referring again to FIG. 2, non-limiting embodiments of the method 2000 may further include, at step 214, performing the industrial process as modified at step 212 to produce a product. Performing the industrial process may include actuating, with at least one processor of the client device 120 or with at least one processor of the server computer 108, one or more of the modules of the one or more industrial devices 104.

With continued reference to FIG. 2, non-limiting embodiments of the method 2000 may further include, at step 216, obtaining at least one measured product property of the product produced by the industrial process at step 214. The at least one measured product property may be obtained directly or indirectly from the one or more process data sensors 117.

With continued reference to FIG. 2, non-limiting embodiments of the method 2000 may further include, at step 218, training and/or retraining at least one machine learning model based on the measured product property obtained at step 216. The measured product property may be added to a data set containing data from previous performances of the industrial process. The at least one machine learning model may then be trained and/or retrained with the updated data set including the measured product property obtained at step 216. Further details of non-limiting embodiments for training and/or retraining the at least one machine learning model described in greater detail herein with reference to FIG. 8 and the associated description of the method 8000.

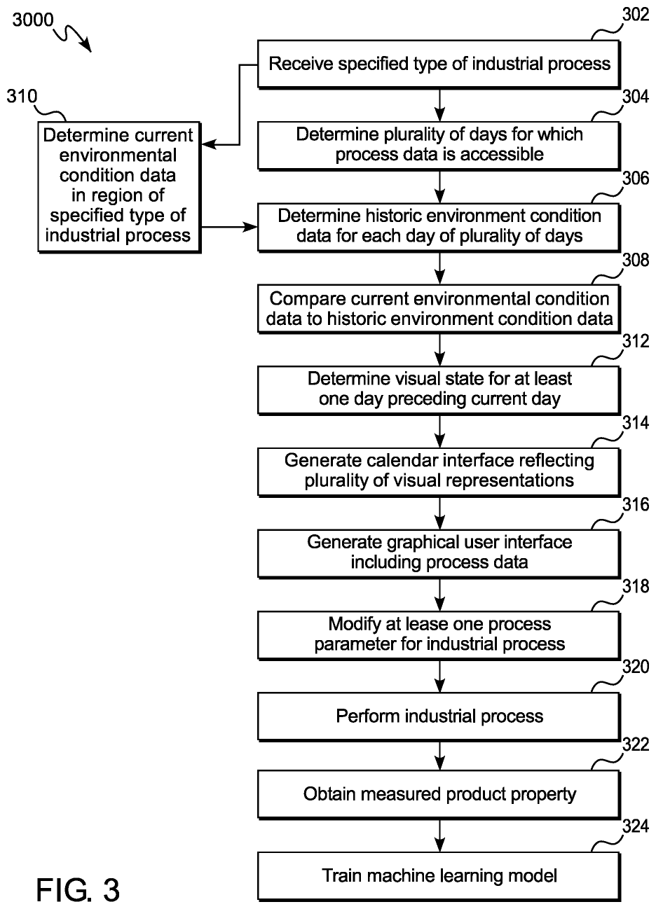

Referring now to FIG. 3, a flow diagram for a method 3000 of optimizing an industrial process is shown in accordance with a non-limiting embodiment of the present disclosure. Steps of the method 3000 which are the same or similar to steps of the method 2000 will not be described in great detail. Referring to FIG. 3, at step 302, a specified type of industrial process is received by at least one processor of the client device 120 and/or at least one processor of the server computer 108. In non-limiting embodiments, the specified type of industrial process may be input by the user via the client device 120. In non-limiting embodiments, the specified type of industrial process may include an industrial process for making a particular type of product, such as a polyurethane foam, from a specified reaction mixture. In non-limiting embodiments, the reaction mixture for producing a polyurethane foam may include a polyisocyanate, a polyisocyanate-reactive compound, a blowing agent, and/or combinations thereof. The polyisocyanate-reactive compound may include water. In non-limiting embodiments, the specified type of industrial process may include target properties of a finished product produced by the industrial process. For example, the target properties may include a target density, a raw density according to DIN EN ISO 845, a target IFD hardness, and/or a compression load deflection at 40% compression according to EN ISO 3386.

At step 304, the method 3000 includes determining a plurality of days preceding the specified day for which process data associated with the specified type of industrial process is accessible. The process data for the plurality of days may be stored in the historic process data database 118. At least one processor of the client device 120 and/or at least one processor of the server computer 108 may parse the historic process data database 118 to determine what of the process data stored in the historic process data database 118 is associated with the specified type of industrial process. For example, the specified type of industrial process from step 302 may include a “GradeA” recipe. The historic process data database 118 is then parsed to find process data for days associated with a “GradeA” recipe. FIG. 7 shows the process data from the historic process data database 118 associated with a plurality of days for which the “GradeA” recipe specified type of industrial process was performed.

Referring again to FIG. 3, at step 306, the method 3000 includes determining historic environment condition data for each day of the plurality of days. Specifically, the historic environment condition data is retrieved from the historic process data database 118 for each day of the plurality of days determined at step 306. At step 308, the method 3000 includes comparing current environmental condition data to historic environment condition data for each day preceding a specified day, as determined at step 304. In non-limiting embodiments, retrieval of the historic environment condition data at step 306 and the comparison of step 308 may be performed substantially as described herein in connection with step 202 of the method 2000.

In some non-limiting embodiments, step 308 may be preceded by step 310, in which current environmental condition data is determined for the specified day in a region in which the specified type of industrial process is being performed. Step 310 may be performed substantially as described herein in connection with step 204 of the method 2000.

At step 312, the method 3000 includes determining a visual state from a plurality of visual states for each day of the plurality of days based on the comparison between the current environmental condition data and the historic environment condition data for each day. In non-limiting embodiments, step 312 may be performed substantially as described herein in connection with step 206 of the method 2000.

At step 314, the method 3000 includes generating a calendar interface including a plurality of visual representations. Each visual representation corresponds to a day of the plurality of days determined at step 304, and each visual representation includes the visual state determined for the corresponding day. In non-limiting embodiments, step 314 may be performed substantially as described herein in connection with step 208 of the method 2000.

In some non-limiting embodiments, the method 3000 may further include, at step 316, generating a GUI including process data for at least one day corresponding to at least one visual representation of the calendar interface selected by the user. The process data included in the GUI may include historical data for the specified type of industrial process. In non-limiting embodiments, step 316 may be performed substantially as described herein in connection with step 210 of the method 2000.

In some non-limiting embodiments, the method 3000 may further include, at step 318, modifying at least one process parameter for the specified type of industrial process based on the process data for the at least one day corresponding to the visual representation selected by the user at step 316. In non-limiting embodiments, step 318 may be performed substantially as described herein in connection with as step 212 of the method 2000.

In some non-limiting embodiments, the method 3000 may further include, at step 320, performing the specified type of industrial process as modified at step 318 to produce a product. In non-limiting embodiments, step 320 may be performed substantially as described herein in connection with step 214 of the method 2000.

In some non-limiting embodiments, the method 3000 may further include, at step 322, obtaining at least one measured product property of the product produced by the industrial process at step 320. In non-limiting embodiments, step 322 may be performed substantially as described herein in connection with step 216 of the method 2000.

In some non-limiting embodiments, the method 3000 may further include, at step 324, training and/or retraining at least one machine learning model based on the measured product property obtained at step 322. In non-limiting embodiments, step 324 may be performed substantially as described herein in connection with step 218 of the method 2000.

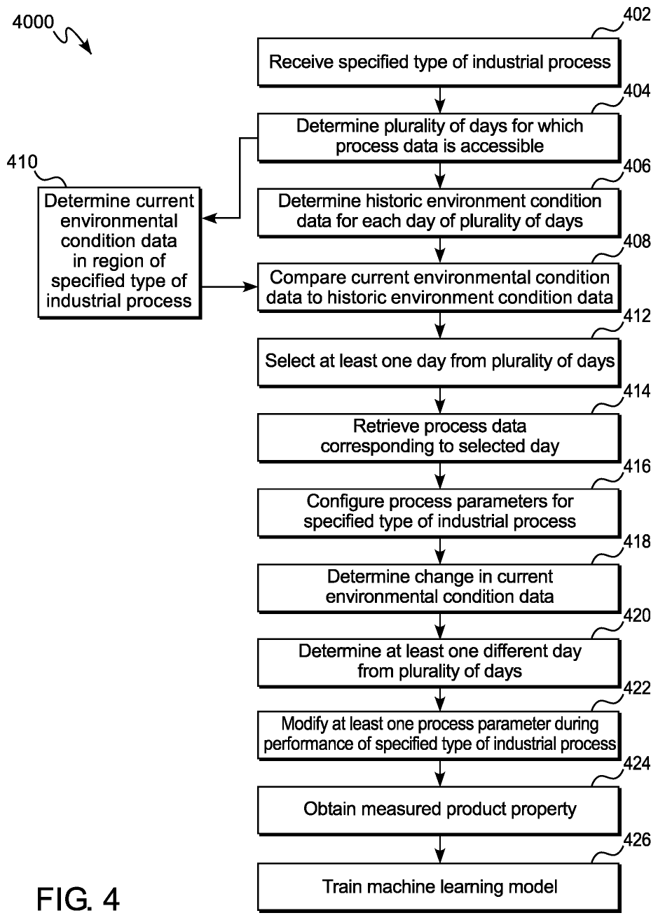

Referring now to FIG. 4, a flow diagram for a method 4000 of optimizing an industrial process is shown in accordance with another non-limiting embodiment of the present disclosure. Steps of the method 4000 which are the same or similar to steps of the method 3000 will not be described in great detail. In particular, steps 402-410 of the method 4000 may be substantially performed as steps 302-310, respectively, of the method 3000. At step 412, the method 4000 includes selecting at least one day of the plurality of days based on the comparison performed at step 308. The selection of at least one day in step 412 is performed by at least one processor of the client device 120 or at least one processor of the server computer 108. In non-limiting embodiments, the selection of the at least one day may be automatically performed based on the differential between the current environmental condition data and the historic environment condition data for each of the plurality of days. In particular, at least one processor of the client device 120 or at least one processor of the server computer 108 may automatically select the day associated with historic environment condition data which has the lowest differential from the current environmental condition data.

With continued reference to FIG. 4, at step 414, process data corresponding the at least one day selected at step 412 is retrieved. In particular, at least one processor of the client device 120 or at least one processor of the server computer 108 may retrieve the process data from the historic process data database 118 associated with the day selected at step 412. At step 416, the process parameters for performing the industrial process are configured based on the process data retrieved at step 414. The process parameters may be automatically configured by at least one processor of the client device 120 or at least one processor of the server computer 108. In non-limiting embodiments, the process parameters may be configured to match at least a portion of the process data retrieved from the historic process data database 118 at step 414. For example, the process parameters may include water flow rate and polyurethane temperature, and the at least one day selected at step 410 may by Jan. 7, 2019. At least one processor of the client device 120 and/or at least one processor of the server computer 108 may configure the process parameters of the specified type of industrial process to match those from Jan. 7, 2019. As shown in FIG. 7, the process data associated with Jan. 7, 2019 includes a water flow rate of 21.26 lbs/min and a polyurethane temperature of 68.1° F. Accordingly, the process parameters of the specified type of industrial process may be configured to have a water flow rate of 21.26 lbs/min and a polyurethane temperature of 68.1° F., matching the process data for Jan. 7, 2019.

In some non-limiting embodiments, at least one processor of the client device 120 and/or at least one processor of the server computer 108 may interpolate or extrapolate from the process data retrieved at step 414 to configure the at least one process parameter based on a differential between the current environmental condition data and the historic environment condition data associated with the at least one day selected at step 412. For example, if the current environmental condition data includes a different grains of moisture than the grains of moisture of the selected at least one day, at least one processor of the client device 120 and/or at least one processor of the server computer 108 may configure the process parameters to deviate from the process data associated with the selected day in order to account for the difference in grains of moisture. At least one processor of the client device 120 and/or at least one processor of the server computer 108 may implement machine learning, using data from previously-performed iterations of one or more industrial processes in order to interpolate or extrapolate from the process data retrieved at step 414.

In some non-limiting embodiments, the parameters may be configured to deviate from the process data associated with the selected day, in order to change a product property of the product produced from the specified type of industrial process. For example, the day selected at step 412 may be Jan. 7, 2019 which produced a product having a 25% IFD hardness of 26.91 lb/50 in\hat{ }2 (as shown in FIG. 7). However, the user may input into the client device 120 a target 25% IFD hardness of more or less than 26.91 lb/50 in\hat{ }2. At least one processor of the client device 120 and/or at least one processor of the server computer 108 may configure the process parameters based on the process data associated with Jan. 7, 2019 (e.g. water flow rate of 21.26 lbs/min and a polyurethane temperature of 68.1° F.), but may alter the process parameters in order to produce a product having the target 25% IFD hardness. That is, the process data associated with Jan. 7, 2019 may be used as a baseline for configuring the process parameters, but the final configuration of the process parameters may be deviated from the process data associated with Jan. 7, 2019 in order to produce the target product property. In some non-limiting embodiments, at least one processor of the client device 120 and/or at least one processor of the server computer 108 may utilize a machine learning model, including a data set based on a plurality of previous performances of the specified type of industrial process, to predict optimum reaction mixture and process conditions to attain the target product property, using the optimum reaction mixture and process conditions for Jan. 7, 2019 as a baseline.

With continued reference to FIG. 4, non-limiting embodiments of the method 4000 may further include, at step 418, determining a change in the current environment condition data during performance of the specified type of industrial process. In non-limiting embodiments, determining the change in current environment condition data may include retrieving and/or receiving updated current environmental condition data via the one or more process data sensors 117 and/or the third party database 124. The updated current environmental condition data may be compared to the current environmental condition data used in the comparison of step 410 to determine whether a change in the current environmental condition data has occurred. The determination of a change in the current environmental condition data may be performed by at least one processor of the client device 120 and/or at least one processor of the server computer 108.

With continued reference to FIG. 4, non-limiting embodiments of the method 4000 may further include, at step 420, determining at least one different day of the plurality of days based on a comparison between the changed current environmental condition data and historic environment condition data associated with the at least one different day. The selection of at least one different day at step 420 is performed by at least one processor of the client device 120 or at least one processor of the server computer 108. In non-limiting embodiments, the selection of the at least one different day may be automatically performed based on the differential between the updated current environmental condition data and the historic environment condition data for each of the plurality of days. In particular, at least one processor of the client device 120 or at least one processor of the server computer 108 may automatically select the at least one different day associated with historic environment condition data which has the lowest differential from the updated current environmental condition data.

With continued reference to FIG. 4, non-limiting embodiments of the method 4000 may further include, at step 422, modifying at least one of the process parameters configured at step 416 based on the process data for the at least one different day determined at step 420. The at least one process parameter may be modified during performance of the specified type of industrial process. Specifically, the at least one process parameter may be modified to match the process data for the at least one different day. In non-limiting embodiments, step 422 may be similar to step 416, except that at least one processor parameter is modified to match the process data associated with the at least one different day determined at step 420 rather than configured to match the process data associated with the at least one different day selected at step 412. As in step 416, in non-limiting embodiments, the at least one process parameter may be deviated from the process data associated with the at least one different day in order to attain a target product property of the product produced by the specified type of industrial process. In non-limiting embodiments, the at least one process parameter may be modified according to a machine learning model.

In some non-limiting embodiments, the method 4000 may further include, at step 424, obtaining at least one measured product property of the product produced by the industrial process at step 422. In non-limiting embodiments, step 424 may be performed substantially as described herein in connection with step 216 of the method 2000.

In some non-limiting embodiments, the method 4000 may further include, at step 426, training and/or retraining at least one machine learning model based on the measured product property obtained at step 424. In non-limiting embodiments, step 426 may be performed substantially as described herein in connection with step 218 of the method 2000.

As discussed herein, the industrial process in some non-limiting embodiments may be a method of producing a chemical product from a reaction mixture containing two or more ingredients. Referring now to FIG. 8, a flow diagram for a method 8000 of producing a chemical product is shown in accordance with a non-limiting embodiment of the present disclosure. At step 802, the method 8000 includes generating at least one machine learning model configured to determine predicted reaction mixture data. Generating the at least one machine learning model may be performed by at least one processor of the client device 120 or by at least one processor of the server computer 108. The predicted reaction mixture data may be based on at least one input environmental parameter and at least one input product property. The predicted reaction mixture data may include at least one of a composition of a reaction mixture and/or process conditions of a reaction mixture. That is, the at least one machine learning model may be configured to output a recommended composition of a reaction mixture and/or recommended process conditions of the reaction mixture based on inputs of at least one of an environmental parameter and/or a product property.

With continued reference to FIG. 8, at step 804, the method 8000 may include training the at least one machine learning model generated at step 802 based on a data set including a plurality of production instances of producing the chemical product. The data set may include, for example, data related to each production instance such as the reaction mixture composition data associated with each production instance, environmental condition data at the production site associated with each production instance, and combinations thereof. In non-limiting embodiments, the reaction mixture composition data may correspond to data related to one or more process parameters of the industrial process (e.g. ingredient flow rate, ingredient temperature, relative ingredient ratios, catalyst addition, heating parameters, mixing parameters, conveying speed and/or the like) stored in the historic process data database 118, and the environmental condition data may correspond to the historic environment condition data stored in the historic process data database 118. In non-limiting embodiments, part or all of the data set may be stored in the third party database 124. Training the machine learning model at step 804 may be performed by at least one processor of the client device 120 or by at least one processor of the server computer 108.

With continued reference to FIG. 8, at step 806, the method 8000 may include determining the predicted reaction mixture data based on processing input data according to the at least one machine learning model. The processing input data may include a measured environmental parameter and at least one target product property. In non-limiting embodiments, the processing input data may be received directly or indirectly from the one or more process data sensors 117. In non-limiting embodiments, the processing input data may be received via a GUI, such as the one or more GUIs 122 displayed on the client device 120. Determining the predicted reaction mixture at step 806 may be performed by at least one processor of the client device 120 or by at least one processor of the server computer 108. In non-limiting embodiments, the predicted reaction mixture data, once determined, may be displayed on a GUI, such as the one or more GUIs 122 displayed on the client device 120.

In some non-limiting embodiments, step 806 may include modifying a predetermined mixture composition by adjusting at least at least one of the composition of the reaction mixture and/or process conditions for the reaction mixture. The predetermined mixture composition may be, for example, a reaction mixture including nominal quantities of ingredients standardized for particular environmental conditions. The composition of the reaction mixture may include, for example, a molar ratio of isocyanate groups to isocyanate-reactive groups, an amount of blowing agent, an amount of physical blowing agent relative to an amount of chemical blowing agent, and/or combinations thereof. Process conditions for the reaction mixture may include, for example, ingredient flow rate, ingredient temperature, conveying speed, and/or combinations thereof. Modifying the predetermined reaction mixture at step 816 may be performed by at least one processor of the client device 120 or by at least one processor of the server computer 108.

With continued reference to FIG. 8, at step 808, the method 8000 may include producing the chemical product based on the predicted reaction mixture data. Producing the chemical product may include actuating, with at least one processor of the client device 120 or with at least one processor of the server computer 108, one or more of the modules of the one or more industrial devices 104.

With continued reference to FIG. 8, at step 810, the method 8000 may include obtaining at least one measured product property of the chemical product produced at step 808. The at least one measured product property may be obtained directly or indirectly from the one or more process data sensors 117.

With continued reference to FIG. 8, at step 812, the method 8000 may include modifying the at least one machine learning model generated at step 802 based on the at least one measured product property obtained at step 810. In non-limiting embodiments the at least one machine learning model may be modified by adding the at least one measured property obtained at step 810 to the data set and re-training the at least one machine learning model by repeating step 804.

With continued reference to FIG. 8, non-limiting embodiments of the method 8000 may further include, at step 814, removing outliers from the data set based on a statistical algorithm. Step 814 may be performed prior to training the at least on machine learning model at step 804 such that outliers of the data set may not influence the training of the at least one machine learning model. The statistical algorithm may include any method for identifying outliers in the data set such as graphical methods, model-based methods, and combinations thereof.

With continued reference to FIG. 8, non-limiting embodiments of the method 8000 may further include, at step 816, receiving an updated measured environmental parameter from the production site of the chemical product. The updated measure environmental parameter may be received while producing the chemical product at step 808. In non-limiting embodiments, the updated measure environmental parameter may be obtained directly or indirectly from the one or more process data sensors 117.

Non-limiting embodiments of the method 8000 may further include, at step 818, determining whether to update the predicted reaction mixture data based on the updated measure environmental parameter received at step 816. The determination at step 818 may be performed by at least one processor of the client device 120 or by at least one processor of the server computer 108. The determination at step 818 may be based on comparing the updated measured environmental parameter received at step 818 to the measured process parameter received at step 806. If it is determined at step 818 to not update the predicted reaction mixture data, production of the chemical product at step 808 may proceed with the prediction reaction mixture determined at step 806.

Alternatively, if it is determined at step 818 to update the predicted reaction mixture data, the method 8000 may further include, at step 820, adjusting at least one of the composition of the reaction mixture and/or process conditions for the reaction mixture. In non-limiting embodiments, adjusting at least one of the composition of the reaction mixture and/or process conditions for the reaction mixture may be performed in response to a determination that the updated measured environmental parameter received at step 816 to the measured environmental parameter received at step 806 are different. After at least one adjustment of the composition of the reaction mixture and/or process conditions for the reaction mixture at step 820, step 808 may resume to produce the product.

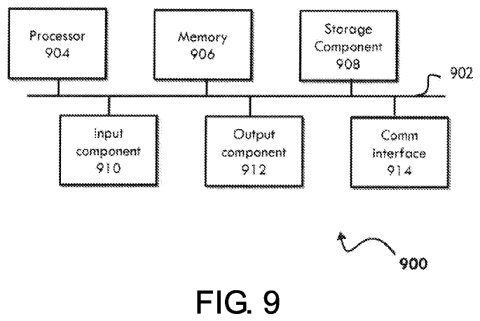

Referring now to FIG. 9, shown is a diagram of example components of a device 900 according to non-limiting embodiments. Device 900 may correspond to the client device 102, server computer 108, and/or one or more industrial devices 104 shown in FIG. 1. In some non-limiting embodiments, such systems or devices may include at least one device 900 and/or at least one component of device 900. The number and arrangement of components shown in FIG. 9 are provided as an example. In some non-limiting embodiments, device 900 may include additional components, fewer components, different components, or differently arranged components than those shown in FIG. 9. Additionally, or alternatively, a set of components (e.g., one or more components) of device 900 may perform one or more functions described as being performed by another set of components of device 900.

As shown in FIG. 9, device 900 may include a bus 902, a processor 904, memory 906, a storage component 908, an input component 910, an output component 912, and a communication interface 914. Bus 902 may include a component that permits communication among the components of device 900. In some non-limiting embodiments, processor 904 may be implemented in hardware, firmware, or a combination of hardware and software. For example, processor 904 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 906 may include random access memory (RAM), read only memory (ROM), and/or another type of dynamic or static storage device (e.g., flash memory, magnetic memory, optical memory, etc.) that stores information and/or instructions for use by processor 904.

With continued reference to FIG. 9, storage component 908 may store information and/or software related to the operation and use of device 900. For example, storage component 908 may include a hard disk (e.g., a magnetic disk, an optical disk, a magneto-optic disk, a solid state disk, etc.) and/or another type of computer-readable medium. Input component 910 may include a component that permits device 900 to receive information, such as via user input (e.g., a touch screen display, a keyboard, a keypad, a mouse, a button, a switch, a microphone, etc.). Additionally, or alternatively, input component 910 may include a sensor for sensing information (e.g., a global positioning system (GPS) component, an accelerometer, a gyroscope, an actuator, etc.). Output component 912 may include a component that provides output information from device 900 (e.g., a display, a speaker, one or more light-emitting diodes (LEDs), etc.). Communication interface 914 may include a transceiver-like component (e.g., a transceiver, a separate receiver and transmitter, etc.) that enables device 900 to communicate with other devices, such as via a wired connection, a wireless connection, or a combination of wired and wireless connections. Communication interface 914 may permit device 900 to receive information from another device and/or provide information to another device. For example, communication interface 914 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 900 may perform one or more processes described herein. Device 900 may perform these processes based on processor 904 executing software instructions stored by a computer-readable medium, such as memory 906 and/or storage component 908. A computer-readable medium may include any non-transitory memory device. A memory device includes memory space located inside of a single physical storage device or memory space spread across multiple physical storage devices. Software instructions may be read into memory 906 and/or storage component 908 from another computer-readable medium or from another device via communication interface 914. When executed, software instructions stored in memory 906 and/or storage component 908 may cause processor 904 to perform one or more processes described herein. Additionally, or alternatively, hardwired circuitry may be used in place of or in combination with software instructions to perform one or more processes described herein. Thus, embodiments described herein are not limited to any specific combination of hardware circuitry and software. The term “programmed or configured,” as used herein, refers to an arrangement of software, hardware circuitry, or any combination thereof on one or more devices.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

1. A computer-implemented method of optimizing an industrial process based on at least one environmental parameter, comprising:
comparing, with at least one processor, current environmental condition data to historic environment condition data for at least one day preceding a specified day;
determining, with at least one processor, a visual state from a plurality of visual states for the at least one day based on the comparison between the current environmental condition data and the historic environment condition data;
generating, with at least one processor, a calendar interface comprising a plurality of days preceding the specified day and corresponding to a plurality of visual representations, wherein at least one visual representation corresponding to the at least one day comprises the visual state; and
in response to receiving a user selection of the at least one day of the plurality of days, generating a graphical user interface comprising process data for the at least one day, the process data including historical data for at least one type of industrial process.

2. The computer-implemented method of claim 1, further comprising determining, with at least one processor, the current environmental condition data for the specified day for a region in which the at least one type of industrial process is being performed.

3. The computer-implemented method of claim 1, wherein determining the visual state of the at least one day comprises:
determining a subset of days of the plurality of days based on an availability of data for the at least one specified type of industrial process; and
determining a visual state for each day of the subset of days based on the comparison of the current environmental condition data to historic environment condition data for that day, wherein each visual state of the plurality of visual states is based on a differential between the current environmental condition data and the historic environment condition data.

4. The computer-implemented method of claim 3, further comprising generating a plurality of visual representations from the plurality of visual states, wherein the plurality of visual states comprises a plurality of colors, and wherein each visual representation of the plurality of visual representations represents a different day of the plurality of days.

5. The computer-implemented method of claim 1, further comprising modifying at least one process parameter for an industrial process based on the process data for the at least one day.

6. The computer-implemented method of claim 5, further comprising controlling an ingredient addition device based on the at least one process parameter.

7. The computer-implemented method of claim 1, wherein the graphical user interface comprising process data includes at least one graph showing a plurality of discrete instances of the industrial process according to at least one process parameter, the method further comprising:
receiving a user selection of at least one discrete instance of the industrial process from the at least one graph; and
generating a graphical user interface comprising process parameters for the at least one discrete instance of the industrial process.

8. A computer-implemented method of optimizing an industrial process based on at least one environmental parameter, comprising:
receiving, with at least one processor, a specified type of industrial process;
determining, with at least one processor, a plurality of days preceding a specified day for which process data associated with the specified type of industrial process is stored in a database;
determining, with at least one processor, historic environment condition data for each day of the plurality of days;
comparing, with at least one processor, current environmental condition data to the historic environment condition data for each of the plurality of days;
determining, with at least one processor, a visual state from a plurality of visual states for each day of the plurality of days based on the comparison between the current environmental condition data and the historic environment condition data for each day; and
generating, with at least one processor, a calendar interface comprising a plurality of visual representations, each visual representation corresponding to a day of the plurality of days and comprising the visual state determined for the corresponding day.

9. The computer-implemented method of claim 8, further comprising:
receiving a user selection of at least one visual representation of the plurality of visual representations; and
generating a graphical user interface comprising process data for at least one day corresponding to the at least one visual representation of the user selection, the process data including historical data for the specified type of industrial process.

10. The computer-implemented method of claim 9, further comprising determining, with at least one processor, the current environmental condition data for the specified day for a region in which the specified type of industrial process is being performed.

11. The computer-implemented method of claim 8, wherein the plurality of visual states comprises a plurality of colors.

12. The computer-implemented method of claim 9, further comprising modifying at least one process parameter for the specified type of industrial process based on the process data for the at least one day.

13. The computer-implemented method of claim 12, further comprising controlling an ingredient addition device based on the at least one process parameter.

14. A computer-implemented method of optimizing an industrial process, comprising:
receiving, with at least one processor, a specified type of industrial process;
determining, with at least one processor, a plurality of days preceding a specified day for which process data associated with the specified type of industrial process is stored in a database;
determining, with at least one processor, historic environment condition data for each day of the plurality of days;
comparing, with at least one processor, current environmental condition data to the historic environment condition data for each of the plurality of days;
selecting, with at least one processor, at least one day of the plurality of days based on the comparison between the current environmental condition data and the historic environment condition data for each day of the plurality of days;
retrieving, with at least one processor, process data corresponding to the at least one day from a database; and
configuring process parameters for performing the industrial process based on the process data retrieved from the database.

15. The computer-implemented method of claim 14, further comprising:
determining, with at least one processor and during performance of the specified type of industrial process, a change in the current environmental condition data;
in response to determining the change, determining, with at least one processor, at least one different day of the plurality of days based on a comparison between the changed current environmental condition data and historic environment condition data for the at least one different day; and
modifying, with at least one processor, at least one of the process parameters for the specified type of industrial process during performance of the specified type of industrial process.

16.-44. (canceled)
